(19) United States
(12) Patent Application Publication
(10) Pub. No.: US 2007/0071423 A1
(43) Pub. Date: Mar. 29, 2007

(54) Underwater adaptive camera housing

(76) Inventors: Stephen J. Fantone, Lynnfield, MA (US); Stephen D. Fantone, Lynnfield, MA (US); Shaju M. Puthussery, Weymouth, MA (US)

Correspondence Address: FRANCIS J. CAUFIELD, 6 APOLLO CIRCLE, LEXINGTON, MA, 02421-7025, US

(21) Appl. No.: 11/526,980

(22) Filed: Sep. 26, 2006

Related U.S. Application Data
(60) Provisional application No. 60/720,705, filed on Sep. 27, 2005.
(60) Provisional application No. 60/830,224, filed on Jul. 12, 2006.

(51) Int. Cl. G03B 17/08

(52) U.S. Cl. 396/27

(57) ABSTRACT

An adaptive underwater camera housing and control interface for use with a broad range of camera brands and models. The camera housing is preferably formed of front and rear housing sections that are molded of clear transparent plastic and arranged to be moved between an open position for mounting a camera within the housing and a closed position in which the housing provides a watertight enclosure for protecting and communicating with a camera. Residing in the housing are a controller and communications interface by which a camera can be operated from outside the housing. Magnetic signals are preferably passed to the controller by external signal buttons operated by the user. The external signal buttons do not penetrate the interior surfaces of the housing thereby enhancing its water tightness. The housing is provided with a truncated hemispherical lens through which a camera views scenes to be photographed to reduce distortion and not foreshorten viewing angle and a flat window and diffuser for providing controlled artificial illumination to a scene.

### CROSS REFERENCE TO RELATED APPLICATIONS

This application claims the benefit of priority from earlier filed U.S. Provisional Patent Application No. 60/720,705 filed on Sep. 27, 2005 with the title UNDERWATER ADAPTIVE CAMERA HOUSING and U.S. Provisional Patent Application No. 60/830,224 filed on Jul. 12, 2006 with the title UNDERWATER ADAPTIVE CAMERA HOUSING, the contents of both of which are incorporated herein by reference.

### BACKGROUND OF THE INVENTION

This invention in general relates to housings for conventional cameras (film or digital, but primarily digital) and other digital devices with integral photographic capability to be used for underwater applications and, more particularly, to underwater camera housings having exterior controls that do not extend through the wall of the housing forming the watertight enclosure in which the camera resides.

For a variety of reasons, camera manufacturers do not adhere to any standard layout for the arrangement, function, and operation of the controls that must be used in the course of taking pictures. Digital cameras with added displays and menu driven selections for control of camera functions and picture taking settings introduce additional complexity and diversity. As a consequence, makers of underwater camera housings have been forced to provide designs that match the control requirements of individual camera models. Thus, most underwater camera housings are more or less uniquely designed for specific camera models and will work with no others or, at best, with a narrow range of cameras. The fact that each camera requires a unique underwater housing obviously results in higher prices since there is no opportunity to take advantage of economies of scale. In addition, every time a user acquires a new camera, a corresponding new underwater housing must be purchased to match that camera's control arrangement.

In addition to the problems associated with the need for unique underwater camera housings for every camera, other problems exist with current underwater housings for all cameras. One of these arises because of the prevalent use of mechanisms that pass through camera housing walls to actuate camera controls by mechanical interaction as by manually pushing on a rod that has an end protruding from the exterior of the housing. Typically, such a push rod or the like is slidably mounted in a through hole in the housing and is surrounded by O-rings to prevent water from leaking into the housing. Such schemes rely on the integrity and cleanliness of the O-ring seals and their resistance to environmental effects. Often they will leak causing damage to the camera equipment they were expected to protect. In addition, the use of through holes in the housings creates local areas of high stress concentration, which increase with increasing water depth.

Another problem has to do with the optical properties of underwater housings. Typically, a flat window is provided so that the camera taking lens can “see” what a diver intends to photograph. However, the use of flat windows introduces undesirable distortion and narrows the camera's inherent field of view. Moreover, housings with flat transmission windows often cause artificial light from a camera to reflect into the camera where it becomes an unwanted part of the photograph thus degrading its quality.

In view of the many problems associated with known underwater camera housings, it is a primary object of the present invention to provide a universal underwater camera housing that can be used with a large range of commercially available film and digital still and video cameras and other digital devices such as PDAs and cell phones equipped with photographic functionality.

It is yet another object of the present invention to provide an underwater camera housing that can operate a camera with devices that reside solely outside of the housing, without the need for any housing through holes so that water tightness is enhanced and housing stress levels reduced.

It is another object of the present invention to provide underwater camera housings with improved optics for film and digital photography.

It is still another object of the present invention to provide underwater camera housings having interior features for controlling reflections from camera strobes and the like so that they do not reach a camera's detector or film as stray light.

Another object of the present invention is to provide electronic control through the use of exterior signaling devices that can interact with interior controllers and communication interfaces to control camera functions and data transfer.

It is yet another object of the present invention to provide a completely sealable underwater camera housing for a broad range of cameras and the like where camera power can be re-energized and data can be downloaded without breaking the seal.

Other objects of the invention will in part be obvious and will in part appear hereinafter when the following detailed description is read in connection with the appended drawings.

### SUMMARY OF THE INVENTION

The present invention relates to an underwater adaptive camera housing for providing a watertight enclosure and common control interface for cameras and the like that have remote electronic control capability. The housing preferably includes two or more housing sections that are moveable between an open and a closed position in which a camera of the type described is mounted within an enclosure sealed from exposure to surrounding water. At least one of the sections has a transparent, preferably truncated hemispherical-shaped, picture taking window that permits light to be received by an enclosed camera. A locking arrangement keeps the housing sections from freely opening when in the closed position. An adjustable inner mount secures cameras in the housing at a position in optical alignment with the transparent picture taking window. A second flat window is provided in the housing above the picture taking window for emitting strobe illumination to a scene. A diffuser is mounted outside of the housing forward of the illumination window to control the pattern of illumination over the scene. A controller is mounted within the enclosure and is programmed to send and receive commands and data to an enclosed camera via a standard communications interface (such as USB), preferably using the Picture Transfer Protocol (PTP) standard. Externally mounted on the housing are human-operable signaling controls (e.g., buttons) that transmit signals to the controller, which subsequently transmits predetermined commands to the camera.

In one aspect of the invention, no part of the human-operable signaling controls penetrate through the housing's inner surfaces and thus the housing's water tightness is enhanced when closed.

In another aspect of the invention, the transparent picture taking window's preferably truncated hemispherical shape operates to prevent back reflection from internal illumination sources, reduces distortion, increases field of view, and accommodates a variety of different sized and shaped cameras.

In another aspect of the invention, the controller is programmed with standardized command protocols (e.g., PTP, PIMA 15740:2000, Windows WIA) for communication with many commercial camera and video devices.

### BRIEF DESCRIPTION OF THE DRAWINGS

The structure, operation, and methodology of the invention, together with other objects and advantages thereof, may best be understood by reading the detailed description in connection with the drawings in which each part has an assigned numeral that identifies it wherever it appears in the various drawings and wherein:

FIG. 1A is a diagrammatic view of an underwater camera housing and control system in accordance with the invention along with an enclosed camera looking down at them from an upper front right corner perspective;

FIG. 1B is a diagrammatic top view of the camera housing of FIG. 1;

FIG. 2 is an exploded diagrammatic perspective view of the housing camera and of FIG. 1;

FIG. 3 is a diagrammatic view of the underwater housing and camera of FIG. 1 looking at them from an upper rear left corner perspective;

FIG. 4 is top view of the camera and underwater housing of FIG. 1 illustrating various optical features;

FIGS. 5A and 5B are diagrams showing the differences in field of view between a flat camera window versus the hemispherical lens window of the invention;

FIGS. 6A and 6B are plots of differences in distortion for a flat camera window versus the hemispherical lens window of the invention;

FIG. 7 is a diagrammatic plan view of a reed switch and actuating magnet for use with the invention;

FIG. 8 is a high level block diagram of the architecture of the adaptive camera housing of the invention showing the relationships and functions of its various components;

FIG. 9 is a block diagram showing the hardware of the invention for implementing control functions and interfacing with a camera via a USB connector;

FIG. 10 is a block diagram illustrating the layered protocol of the software of the invention; and

FIG. 11 is a flowchart illustrating the various steps carried out by the software.

### DETAILED DESCRIPTION

The present invention relates to an adaptive underwater camera housing and control interface for use with a broad range of camera brands and models. The cameras may BE conventional still and video film cameras, digital still and video cameras, or digital devices provided with photographic capability, such as cell phones or PDAs having integrated digital cameras.

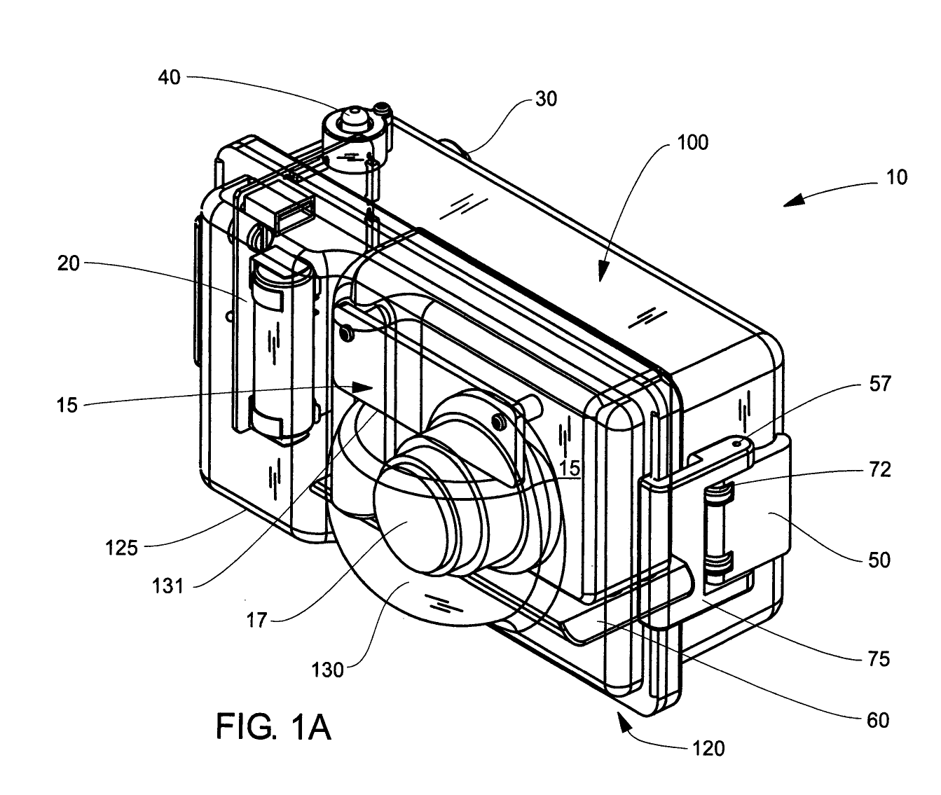

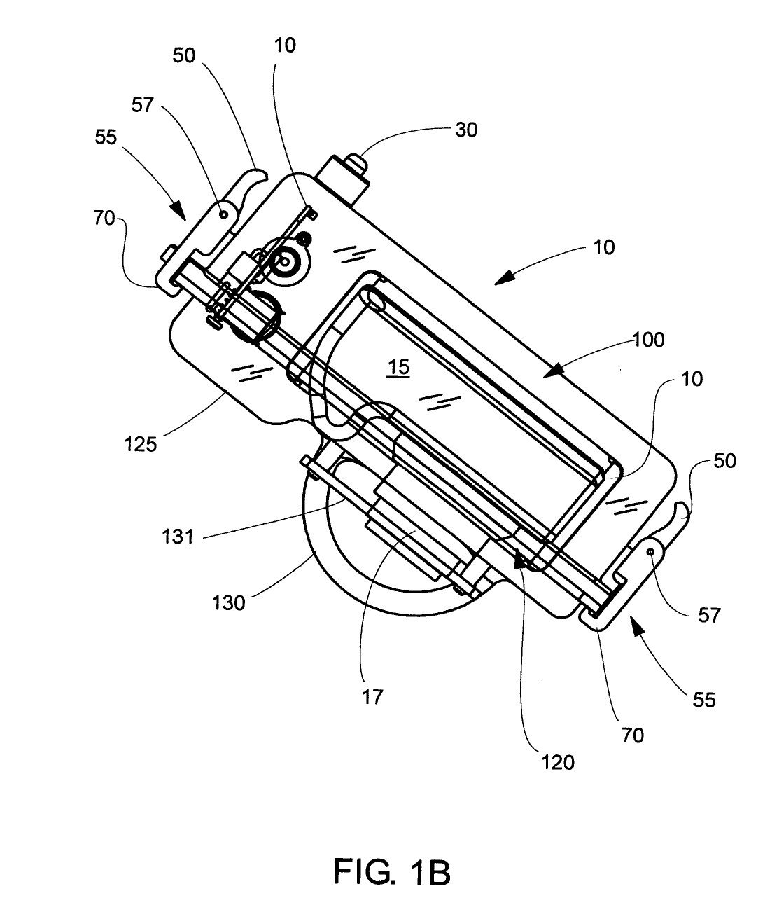

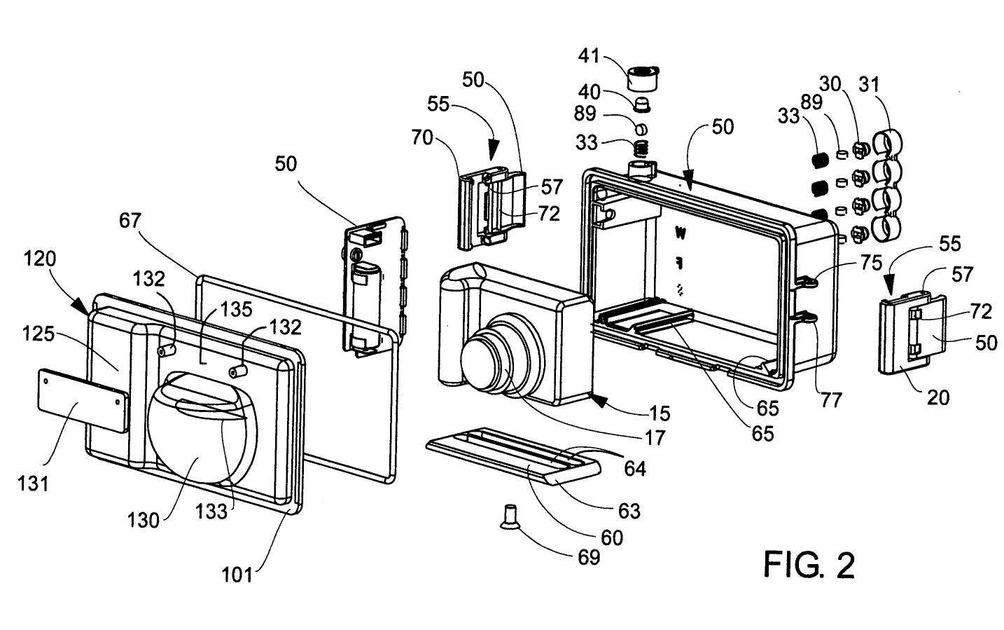

Reference is now made to FIGS. 1A, 1B, 2 and 3, which show an adaptive underwater camera housing, generally designated at 10, in accordance with the invention along with a digital camera 15 located inside of housing 10. These figures show, respectively, an upper right front perspective view, a diagrammatic top view, an exploded perspective view, and an upper-rear perspective view of the inventive underwater housing 10 including its control interface. FIG. 2 is an exploded perspective view of FIG. 1. As seen in those figures, underwater housing 10 comprises rear and front housing sections, 100 and 120, respectively, that are adapted to mate in complementary fashion to form a watertight enclosure for accommodating one of many still or video cameras available in the marketplace, including those of the major brands. Housing sections 100 and 120 are preferably injection molded of an optically clear engineering plastic such as acrylic (index of refraction of 1.492) or polycarbonate (n=1.585).

Camera 15 is secured within housing 10 by a mounting mechanism which allows the position of a camera to be adjusted so that its taking lens 17 is aligned in X, Y, and Z with respect to a truncated hemispherical shaped lens window 130. Camera 15 is fixedly attached and screwed tight to a slotted mounting plate 60 via its tripod interface 69 (See FIG. 2). As described more fully hereinafter, the mounting mechanism in one embodiment includes the mounting plate 60 (shown in FIG. 2) which slidably moves fore and aft with respect to rear camera housing 100 for placement of camera 15 along the Z-direction (optical axis), and perpendicular to it (X, and Y directions).

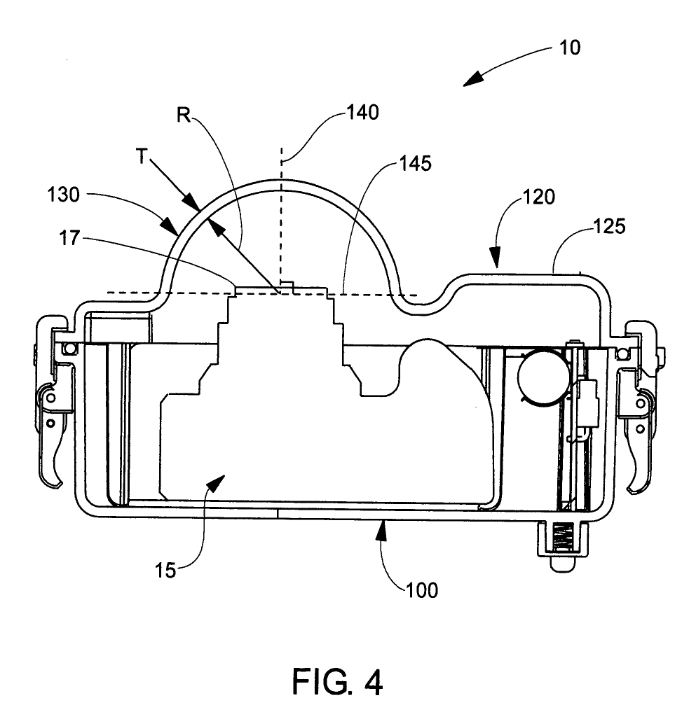

As explained further with reference to FIG. 4, truncated hemispherical shaped lens taking window 130 reduces distortion and controls the disposition of back reflections that would otherwise occur when light from internal light sources reflect off interior housing features. If not controlled by the use of the generally hemispherical window, such reflections could otherwise reflect into taking lens 17 where they could ultimately strike a camera's film or detector as unwanted stray radiation that would reduce the quality of the image

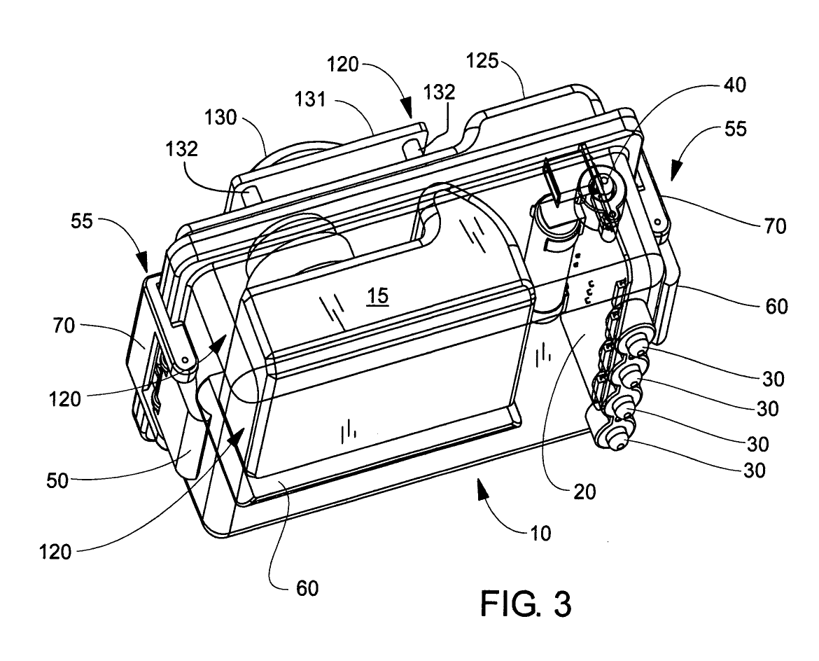

As shown in FIGS. 2 and 3, front housing section 120 has a vertically extending flat window 135 sitting just above the shelf that truncates otherwise hemispherical taking window 130. The flat window 135 aligns with a camera's strobe to provide artificial light for illuminating a scene to be imaged. However, because the strobe window 135 is flat, it reduces the angular field of illumination of strobes so a diffuser 131 has been provided to control the illumination pattern and mitigate against any shadowing caused by the housing itself and any internal baffles. In this connection also, an internal baffle 133 is provided underneath the shelf of the truncated hemispherical taking lens window 130 to prevent light from a strobe or the like from entering the truncated hemispherical taking lens window and thus entering a camera's taking lens as unwanted radiation. The internal baffle 133 may be made of opaque flocking or mylar material and held in place with nubs or adhesive. Diffuser 131 is designed so that it controls the pattern of illumination provided to match the taking field of the camera and is adjusted for parallax effects. To achieve this, diffuser 131 is preferably provided with a series of 90-degree elongated grooves that are normally horizontally oriented to control illumination up and down. Diffuser 131 mounts to the exterior surface of front housing section 120 via a pair of cylindrically shaped, forwardly extending bosses 132.

Because it is transparent, the rear wall of rear housing section 100 acts as a window so that visual displays (e.g., menus, picture previews, etc.) of information located at the rear of camera 15 may be seen when a camera is inside housing 10. Front housing section 120 also has a bumped out section 125 that serves as a handle for gripping and manipulating housing 10 while being used underwater or otherwise being handled or transported. A lanyard may also be attached to housing 10 for transporting it underwater without physically gripping it by hand.

Now referring to FIG. 2, it can be seen that rear and front housing sections, 100 and 120, respectively, are mated with an intervening watertight O-ring 67 and are held together in the closed mated position by left and right side locking mechanisms, each designated generally at 55. Locking mechanisms 55 are pivotally attached to back housing section 100, and each have levers 50 for locking the housing sections in their mated closed position and for releasing them for opening. Levers 50 rotate about corresponding shafts 72 drawn through upper and lower cantilevered tabs 75 and 77 (shown in FIG. 2). Pivotally connected to levers 50 via longer shafts 57 are latch sections 70 that are configured to grip a rim 101 partially surrounding front housing section 120. The various parts forming the latch mechanism are configured and arranged to provide an over-the-center arrangement to clamp shut and release front housing section 120 against rear housing section 100 while compressing intervening O-ring 67 to provide a seal between them.

In a variant of the clamping arrangement above, the sections of housing 10 can be semi-permanently sealed with the use of RTV or the like.

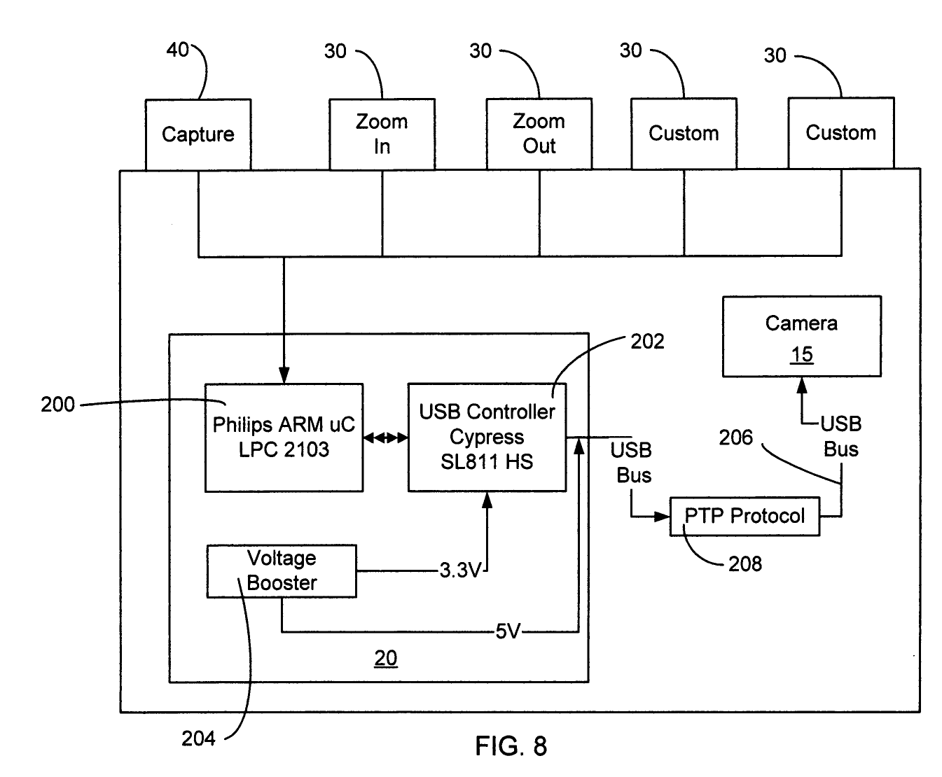

As seen in FIG. 3, camera 15 has an electronic control interface (e.g., USB or other industry standard serial port) that is connected to a controller 20 inside housing 10 via a standard cable (not shown but see FIG. 8, 206). In a manner to be explained in more detail later, camera 15 is selected such that it is remotely operable by one or more of many camera control protocols, such as PTP, PIMA 15740:2000, Microsoft WIA, or proprietary types defined by specific manufacturers. For instance, Nikon and Canon each implement their own version of the PTP protocol in their SDK for many of their cameras. Controller 20 may be programmed to function with one or more of these protocols. In one embodiment of the invention, an external selection switch (not shown) is actuated manually to signal to the controller 20 which of the various protocols is to be used to operate a specific brand and model of camera. In another embodiment of the invention, the controller 20 is configured to automatically detect, via USB, which type of control protocol is compatible with an enclosed camera. It will be apparent to those skilled in the art that the electronic controller 20 can be readily obtained in microcontroller form and that the interface, camera operation, and data transfer functions may be provided in one chip

A vertical array of four identical external buttons 30 are provided on the rear housing section 100 and a single button 40 is provided on the top of rear housing section 100. Buttons 30 reside On housing 31 and button 40 On housing 41. Buttons 30 and button 41 carry magnets 89 (explained in more detail later) and are biased outwardly via springs 33 (See FIG. 2). All are electronically connected to controller 20 and are used to remotely operate camera 15 through the camera's electronic interface. In an embodiment of the invention, the buttons 30 and 40 do not penetrate through the housing sections 100 and 120, but instead transmit signals to the controller 20 through preferably magnetic actuation (e.g., reed, Hall-effect) thereby preventing potential leakage, which characterizes many through-hole type switches. If expense is not a consideration, waterproof switches of the spst momentary switching type may also be used. In addition, IR switches housed entirely inside of housing 10 may be used. With these, an IR light illuminates a wall section and reflects into an IR detector. A finger placed over the illuminated wall section changes the amount of reflection and hence serves as the basis for signaling. A wire (not shown) transmits signals from shutter control button 40 to controller 20 to snap a picture.

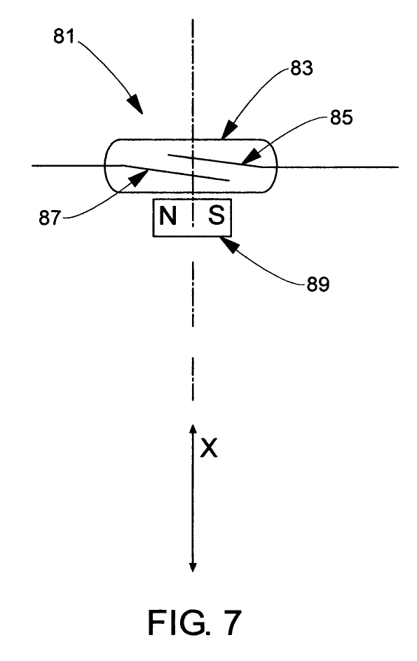

Reference is now made to FIG. 7, which shows one form of reed switch that may be used. As seen there, a dry-reed switch 81 is provided as an assembly containing ferromagnetic contact blades 85 and 87, hermetically sealed in a glass envelope 83 and operated by an externally-generated magnetic field, e.g., that from a permanent magnet 89 connected to spring loaded buttons 30 and 40. The reed switches reside inside housing 10 and are actuated by moving a corresponding button (30, 40) provided with a permanent magnet. Individual magnets 89 may be rotated around their own axes to match magnetic fields to the requirements of corresponding individual reed switches with which they have been matched. They may then be fixed in place to a corresponding button as by gluing. In this manner, variations in the properties of reed switches can be compensated.

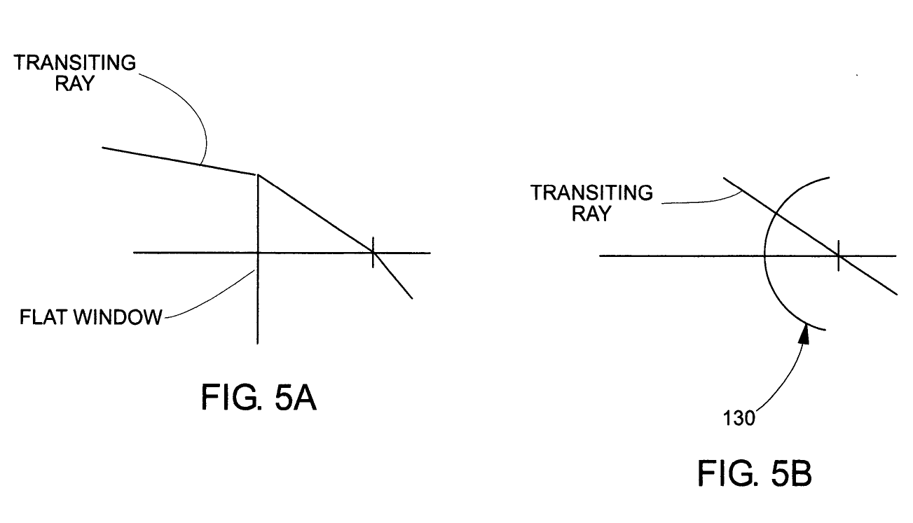

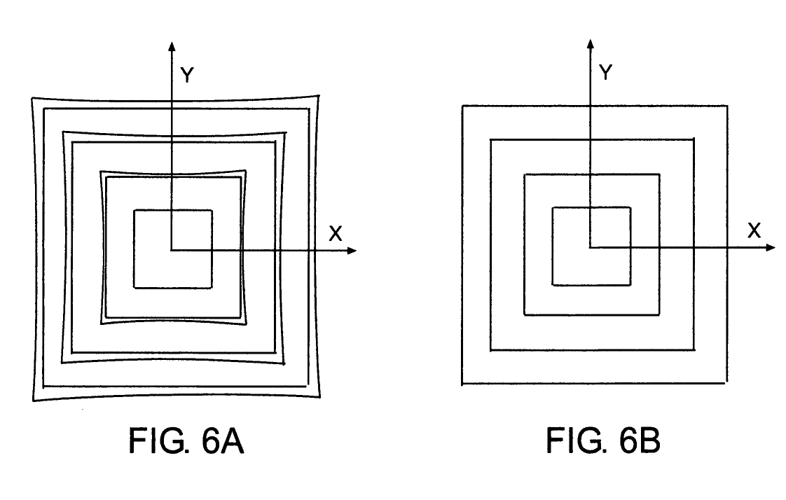

Reference is now made to FIG. 4, which shows the optical features of front housing section 120. As mentioned earlier, the transparent taking window 130 is made hemispherical to reduce distortion and maintain a camera's angular field compared with what it would otherwise be using a flat taking window. This can be appreciated by referring now to FIGS. 5A and 5B which show, respectively, the path of a ray of light as it transits a flat window in an air-water interface as opposed to the path of the same ray transiting the hemispherical taking window of the present embodiment. As can be seen, rays transiting the interface through the hemispherical window do not change direction and hence field of view is unaltered, whereas with a flat window, it is reduced. FIGS. 6A and 6B show, correspondingly, a map of distortion on an image from a flat shaped window (FIG. 6A) and that from a hemispherical taking window. Clearly, FIG. 6B demonstrates that the use of the hemispherical window of the invention substantially eliminates distortion while beneficially not foreshortening the angular field of view of a camera's taking lens. The radius of curvature of hemispherically shaped taking window 130 is preferably otherwise designed to accommodate the full focusing range of a large group of cameras operating in their tele, wide angle, and macro modes over their full zoom range. The range over which the radius can sensibly vary is from approximately 1.0 inches to 6.0 inches. The wall thickness of the camera housing is approximately 0.125 inches.

Referring back to FIG. 4, the camera taking lens 17 and optical axis of the hemispherical window are nominally coincident with the entrance pupil of the taking lens 17. The taking lens entrance pupil preferably nominally resides in a plane 145 perpendicular to those optical axes and passing through the entrance pupil center. The hemispherical window 130 is preferably of uniform thickness. One exemplary design having a focal length of −8.4 inches is made of polycarbonate with a radius of three inches and a thickness of 0.125 inches. Given this design, the requirements for bore sighting a camera with respect to the optical axis of the hemispherical window and the placement of its lens entrance pupil along the optical axis are relatively relaxed; it being estimated that the placement of the entrance pupil along the optical axis can be off by +/− an inch before distortion similar to that produced by a flat window would begin to appear.

In addition to the benefits of low distortion, wide angular field of view, and relative insensitivity to camera placement, the hemispherical lens also permits reflections off it from off-axis illumination from the camera, such as built-in strobes, to be beneficially directed to the interior of the camera housing where it is not seen by the camera taking lens. This is possible because such strobes nominally reside in the vicinity of a plane located near the center of curvature of the hemispherical window, and thus light from them is directed to locations where it does not enter the taking lens as unwanted stray radiation that can affect image quality.

Reference is now made again to FIG. 2, which shows the mechanical arrangement previously mentioned for mounting and holding a camera in alignment with the hemispherical shaped window 130 formed in the front camera housing 120. Here, camera mounting plate 60 is seen to be provided with a pair of spaced apart parallel slots 64 and a pair of spaced apart wedged ends 63 (only one shown). The spaced apart wedged ends 63 slide within a corresponding pair of complementary shaped, spaced apart grooved rails 65 located in rear housing section 100. This arrangement permits a camera 15 to be positioned side-to-side and fore and aft with respect to the hemispherical window 130. This is done by simply selecting the proper slot (64) and sideways position of the camera along it, and then screwing the camera to plate 60 with a ¼-20 bolt 69 via the camera's standard tripod mount. Once this is done, camera 15, now fixed to the plate 60, can be slid into rear housing section 100 by placing the wedged ends 63 in the grooved rails 65 and sliding plate 60 along with an attached camera until seated in rear housing section 100. Vertical alignment can be adjusted, as needed, by the use of spacers or shims that sit atop camera mounting plate 60. Once in position, front housing section 120, when mated with rear housing section 100, traps plate 60 between the two to secure a camera in housing 10. Those skilled in the art will appreciate that the market can be surveyed to determine optimal dimensions so that the underwater housing 10 can accommodate a large segment of available cameras.

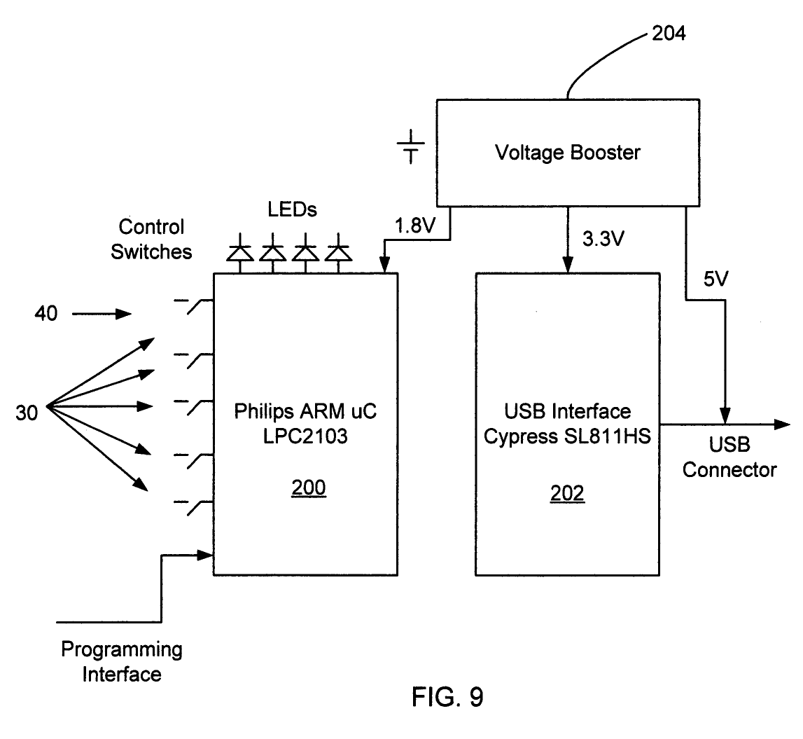

Reference is now made to FIGS. 8 and 9, which show the control and interface architecture and hardware by which a family of cameras can be operated underwater. The USB Camera Interface board, previously designated at 20, acts as a USB host controller to emulate a PC and control the camera, which is now termed the USB Device. This can be done because current cameras can use the PTP transfer protocol as a communication protocol across a USB bus. The hardware for implementing this comprises a Philips LPC 2103 microcontroller (uC) 200 provided with a programming interface to implement control functions with the uC 200 running at 12 MHz (max 60 MHz). The hardware interface to the USB bus 206 is provided by a Cypress SL811HS interface chip 202. Power to all components is provided by one or more AA alkaline batteries or a rechargeable (NiMH) battery, either of which resides in the camera housing 10. Board 20 slides into the rear camera housing section 100 in a pair of spaced apart grooves and is trapped there by the front housing section 120. The circuit requires 3 voltages. The USB host is required to supply 5V to the USB bus (device), The logic uses 3.3V, and the uC core uses a 1.8 V supply. A voltage booster 204 (TPS61010) and associated circuitry converts the battery's voltage (0.9 to 1.5 volts) to a regulated 3.3v and unregulated >5v outputs. Linear regulators are used to derive regulated 5v and 1.8v from these supplies. The LPC2103 microcontroller 200 includes an A-to-D converter which can monitor the battery voltage and detect when the battery is reaching the end of its useful life. The user interface consists of switches 30 and switch 40 and LEDs (FIG. 9) that are monitored and controlled by the uC 200. The design above supports 5 switches and 4 LEDs, but currently calls for 4 switches and 3 LEDs. The USB controller 202 requires a 12 MHz clock for operation. In this design, the uC 200 is operated from a 12 MHz crystal, and the clock signal from the uC 200 is used to drive the controller 202, as well. For faster operation, the microcontroller 200 can internally multiply the clock to a higher frequency (up to 5× or 60 MHz in this case), but the higher speed increases power consumption and is not needed in this application.

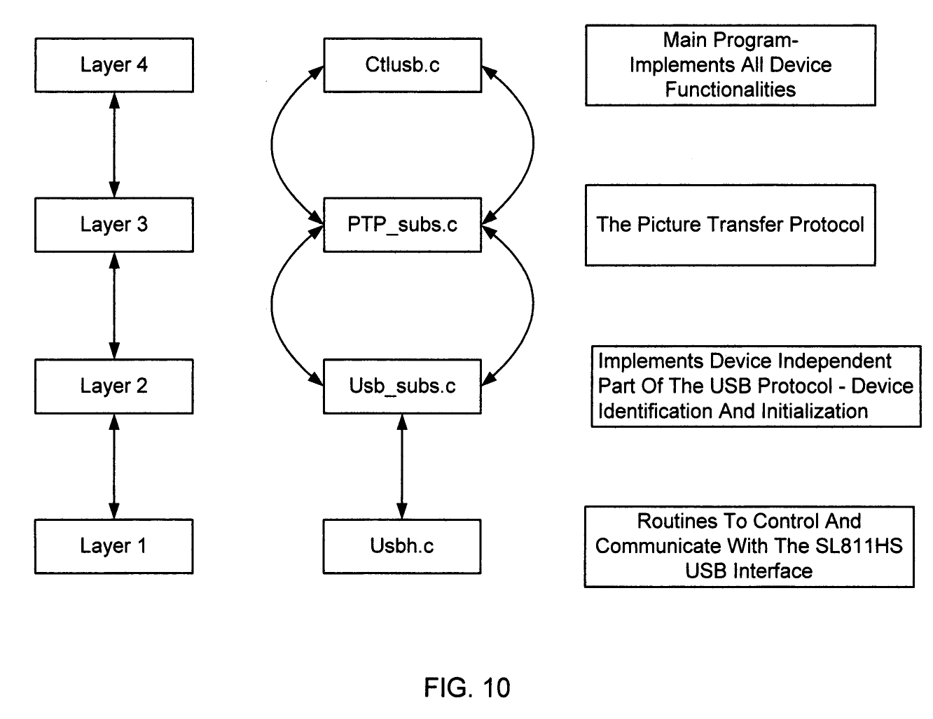

The LPC2103 microcontroller 200 uses the ARM architecture, which is a commercially available architecture that is licensed and used by many manufacturers. A small assembly-language routine is used to initialize and configure the uC 200 on power-up. All other software is written in C using the GNU C compiler. The software is structured as a layered protocol as illustrated in FIG. 10. The lowest layer simply communicates with the SL811HS chip 202, reading and writing its control and status registers). The next layer implements a minimal subset of the USB functionality that is required to initialize and control a camera. The PTP layer uses these USB functions to implement the PTP protocol that is used to send and receive commands and responses to the device. Finally, the main program monitors the switches and uses the PTP protocol to initiate the selected camera functions.

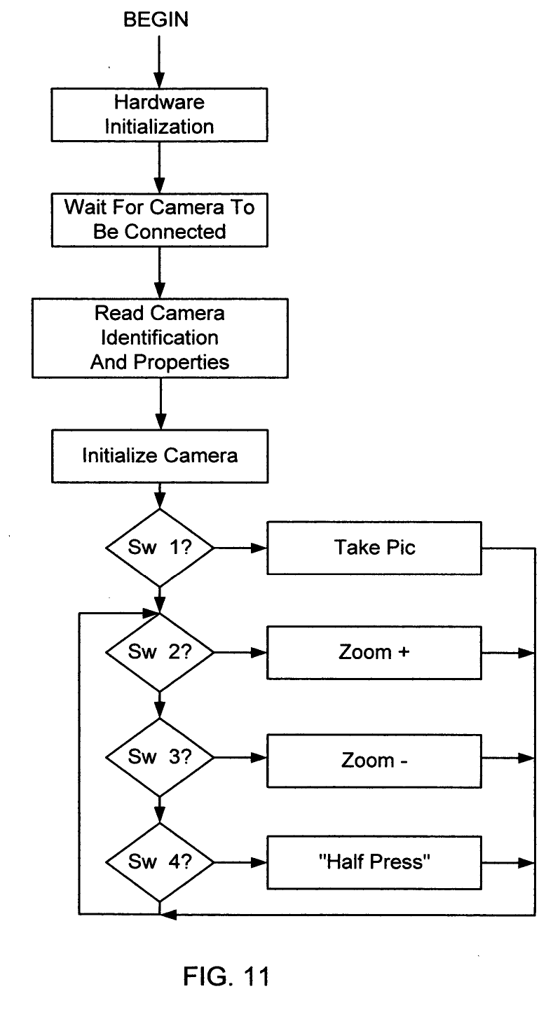

A flowchart illustrating in more detail the various steps carried out by the software is shown in FIG. 11.

Microcontroller 200 has 32 kB of on-chip flash program memory and 8 k of RAM, which is sufficient to support a number of cameras and implement the USB protocols and camera commands. It will be understood that, if necessary, memory can be increased as need be to accommodate additional cameras and/or functionality by selecting a more appropriate microcontroller.

Also, flash memory can be reprogrammed after manufacture to support future enhancements or new camera models and protocols. There are 2 ways to do this:

1) Use can be made of the serial port that is part of the microcontroller 200. This is the normal way that a program is loaded into the microcontroller 200 during development or manufacturing. To do this, use is made of a small interface board to connect to the serial port of a PC and programming software. The parts cost of the interface is inexpensive, and programming software is available for free download from Philips.

2) The chip 202 can function as either a host or device controller, so it can be connected to a PC's USB port to download program upgrades from the PC. The current board design includes parts to support this mode.

A printed circuit board (not shown) may be used in a well-known manner for carrying all of the components shown in FIG. 12. Ultimately, such a printed circuit board becomes the board previously designated generally at 20.

In addition to providing signals to effect the camera functions illustrated, microcontroller 200 can be programmed to instruct a camera to provide other camera functions and to download image data as well.

Having described the invention with respect to specific embodiments, variations of it will be apparent to those skilled in the art based on its teachings. For example, the housing sections can be permanently sealed with a camera inside in which case RF charging can be used to repower internal batteries or download data. In addition, IR links can be used for exchanging data and commands with a camera. Also, a modified version of a Digisnap 2000 controller may be used. This device is marketed by Harbortronics, Gig Harbor, Wash. One useful modified version of the Digisnap uses a Nikon serial port protocol adapted for use with, for example, Nikon Coolpix 8080, 8085, 9090, and 995 cameras. Moreover, the housing of the invention may readily be modified to accept larger cameras, such as SLRs and video types, by scaling and providing appropriate internal support structures, e.g., ribs, for enhanced rigidity and ability to withstand the larger forces generated with increased surface area. Consequently, such variations are intended to be within the scope covered by the appended claims.

What is claimed is:

1. An underwater adaptive camera housing for providing a watertight enclosure and common control interface for cameras of the type configured to use a standardized protocol for electronically sending and receiving commands and/or data, said underwater adaptive housing comprising:
a watertight enclosure for a camera, said watertight enclosure having at least one transparent window for transmitting light to a camera and an inner mount for physically securing a camera in a predetermined relationship with respect to said at least one transparent window;
a controller and standardized electronic communications interface mounted within said watertight enclosure, said controller and standardized electronic communications interface being programmed for receiving signals generated in response to operator action originating outside of said watertight enclosure and transmitting commands and data to and from a camera in accordance with said standardized protocol; and
at least one human-operable signaling device configured to be responsive to human manipulation to generate said signals through said watertight enclosure to said controller and standardized electronic communications interface.

2. The underwater adaptive camera housing of claim 1 wherein said at least one human-operable signaling device is fixedly attached to the outside of said watertight enclosure without penetrating beyond its interior surfaces thereby enhancing the watertight properties of said watertight enclosure.

3. The underwater adaptive camera housing of claim 1 wherein said watertight enclosure is formed of a plurality of camera housing sections adapted to be moveable between open and closed positions to provide said watertight enclosure for a camera when in said closed position.

4. The underwater adaptive camera housing of claim 3 further including a locking arrangement for holding said camera housing sections in said closed position.

5. The underwater adaptive camera housing of claim 1 wherein said controller and standardized electronic communications interface comprise a microcontroller and a separate standardized communications interface.

6. The underwater adaptive camera housing of claim 1 wherein said standardized protocol for electronically sending and receiving commands and data to and from cameras is selected from the group consisting of PTP, PIMA 15740:2000, and Microsoft WIA.

7. The underwater adaptive camera housing of claim 1 wherein said standardized electronic communications interface for transmitting signals between it and a camera is USB.

8. The underwater adaptive camera housing of claim 1 wherein a portion of said transparent window is dome-shaped.

9. The underwater adaptive camera housing of claim 1 wherein said at least one human-operable signaling device is selected from the group consisting of standard waterproof spst momentary switches, Hall effect switches, reed switches, and LED switches.

10. The underwater adaptive camera housing of claim 3 wherein said watertight enclosure further includes an inner mount for physically securing a camera within said watertight enclosure in a predetermined relationship with respect to said at least one transparent window.

11. The underwater adaptive camera housing of claim 6 wherein said transparent window is a truncated hemisphere in shape and wherein said inner mount is configured to align the optical axis of a camera with the optical axis of said truncated hemispherical window and to place the entrance pupil of a camera's taking lens approximately at the radius of curvature of said truncated hemispherical transparent window.

12. The underwater adaptive camera housing of claim 1 wherein said controller and standardized electronic communications interface is programmed to provide one or more of the following camera command set: shutter, zoom-in, zoom-out, review/wake camera, scroll images, manual operation, automatic exposure operation, transfer image data, and delete image.

13. The underwater adaptive camera housing of claim 1 wherein said controller and standardized electronic communications interface further includes a camera identity function by which command sets for particular cameras can be selected.

14. The underwater adaptive camera housing of claim 4 wherein said locking arrangement comprises a pair of over-the-center latches mounted on opposed sides of said housing.

15. The underwater adaptive camera housing of claim 1 wherein one of said camera housing sections includes a transparent window for viewing camera display screens so that pictures and camera menus can be viewed.

16. The underwater adaptive camera housing of claim 1 further including a source mounted within said housing for supplying electrical power to electronic components residing within said underwater adaptive camera housing.

17. The underwater adaptive camera housing of claim 1 wherein said controller and standardized electronic communications interface comprises a microprocessor.

18. The underwater adaptive camera housing of claim 1 wherein said underwater adaptive camera housing is adapted for use with cameras selected from the group consisting of still and video conventional film cameras, still and video digital cameras, cell phones with integral cameras, and PDAs with integral cameras.

19. An underwater adaptive camera housing for providing a watertight enclosure and common control interface for cameras that are configured to use a standardized protocol for electronically sending and receiving commands and data, said underwater adaptive camera housing comprising:
front and back housing sections moveable between open and closed positions to form the camera housing, said front and back housing sections being sized and shaped for enclosing a substantial segment of common hand-held cameras, at least one of said front and back housing sections having a seal and the other a seat by which said front and back housing sections can be made watertight when said seal and seat are mated; said front housing section having at least one transparent window for transmitting and receiving light to and from a camera;
a locking arrangement adapted to hold said front and back housing sections in mated relationship to maintain the water-tight enclosure for a camera;
an inner mount for physically securing a camera within said underwater adaptive camera housing in a predetermined relationship with respect to said at least one transparent window;
a controller mounted within said underwater adaptive camera housing and programmed for receiving and transmitting commands and data according to said standardized protocol;
a standardized electronic communications interface for transmitting signals between said controller and a camera;
at least one human-operable signaling device fixedly attached to the outside of said housing, said signaling device being connected to said housing without penetrating it thus preserving its water tightness when closed, said signaling device being configured to be responsive to human manipulation to generate signals that are transmitted through said housing to said controller to initiate one or more commands that are passed to a camera via said communications interface.

20. The underwater adaptive camera housing of claim 19 wherein said standardized protocol for electronically sending and receiving commands and data to and from said cameras is selected from the group consisting of PTP, PIMA 15740:2000, and Microsoft WIA.

21. The underwater adaptive camera housing of claim 19 wherein said standardized electronic communications interface for transmitting signals between said processor and a camera is USB.

22. The underwater adaptive camera housing of claim 19 wherein a portion of said front housing section transparent window is dome-shaped.

23. The underwater adaptive camera housing of claim 19 wherein said at least one human-operable signaling device is selected from the group consisting of standard waterproof spst momentary switches, Hall effect switches, reed switches, and LED switches.

24. The underwater adaptive camera housing of claim 22 wherein said dome-shaped transparent window is a truncated hemisphere and wherein said inner mount is configured to align the optical axis of a camera with the optical axis of said truncated hemisphere and to place the a camera's taking lens entrance pupil approximately at the radius of curvature of said truncated hemispherical transparent window.

25. The underwater adaptive camera housing of claim 19 wherein said controller is programmed to provide one or more of the following camera command set: shutter, zoom-in, zoom-out, review/wake camera, scroll images, manual operation, automatic exposure operation, image data transfer, and delete image.

26. The underwater adaptive camera housing of claim 19 wherein said controller further includes a camera identity function by which command sets for particular cameras can be selected.

27. The underwater adaptive camera housing of claim 19 wherein said latch comprises a pair of over-the-center hinges mounted on opposed sides of said underwater adaptive camera housing.

28. The underwater adaptive camera housing of claim 19 wherein said rear camera housing includes at least on transparent window section for viewing camera display screens so that pictures and camera menus can be viewed.

29. The underwater adaptive camera housing of claim 19 further including a source mounted within said underwater adaptive camera housing for supplying electrical power to any electronic components residing within said underwater adaptive camera housing.

30. The underwater adaptive camera housing of claim 19 wherein said controller comprises a microprocessor.
